(19) United States
(12) Patent Application Publication
(10) Pub. No.: US 2024/0157733 A1
(43) Pub. Date: May 16, 2024

(54) PNEUMATIC TYRE FOR A VEHICLE

(71) Applicant: Continental Reifen Deutschland GmbH, Hannover (DE)

(72) Inventors: Willem Tomforde, Springe (DE); Ulrich Behr, Hannover (DE); Matthew Lamb, Waxhaw, NC (US)

(21) Appl. No.: 18/548,569

(22) PCT Filed: Dec. 2, 2021
(86) PCT No.: PCT/EP2021/084051

§ 371 Date: Sep. 1, 2023

Related U.S. Application Data
(60) Provisional application No. 63/157,040, filed on Mar. 5, 2021.

(51) Int. Cl. B60C 11/03

(52) U.S. Cl. CPC B60C 11/03; B60C 2011/0341; B60C 2011/039

(57) ABSTRACT

The invention relates to a pneumatic vehicle tire having tread with a shoulder-side rib. An incision is formed in the shoulder-side profile rib and a tubular channel adjoins the incision and runs around it in an L-shape.

### BRIEF SUMMARY

The invention relates to a pneumatic vehicle tire with a tread with at least one shoulder-side tread rib, bounded by a circumferential groove, with an outer surface of tread rib located in the tread periphery, the shoulder-side tread rib having a plurality of transverse grooves that run parallel to one another in plan view and end in front of the circumferential groove, each with a groove base, and on the inside of the tread adjoining the bottom of the groove is an end flank extending to the outer surface of the tread rib.

Such a pneumatic vehicle tire is known, for example, from EP 3 628 510 A1. The pneumatic vehicle tire has a tread with a shoulder-side tread rib with transverse grooves, the transverse grooves having a main section and an outlet section adjoining the main section on the inside of the tread and tapering to the tread rib outer surface. The outlet section is made narrower than the main section, one flank of the transverse groove ending at the outlet section and the other flank of the transverse groove being continued in the outlet section. The groove flank continued in the outlet section lies opposite a flank which is provided with a bevel at least in sections with respect to the outer surface of the profile rib. On the outer surface of the profile rib, the bevel has a bevel edge which adjoins the groove edge of the groove flank ending at the outlet section. Transverse grooves designed in this way reduce the contribution of the shoulder-side profile rib to the rolling noise, while good water drainage on wet ground is still ensured.

The transverse grooves formed in the shoulder-side tread ribs support the drainage of the tread when driving on wet roads, which is particularly important for the aquaplaning behavior of the tire, and provide grip edges on the outer surface of the tread rib, which contribute to improving the wet grip properties. Transverse grooves located in the shoulder-side tread ribs thus play a decisive role with regard to the wet performance of the pneumatic vehicle tire. The design of transverse grooves has to be done in particular taking into account the reduced contact area of the tread rib to the ground caused by the transverse grooves and the reduced rigidity of the tread rib, since a large contact area and high rigidity are advantageous for the dry performance of the pneumatic vehicle tire, for example for handling properties. The wet and dry performance should be retained in particular via the tread wear.

The invention is therefore based on the task of optimizing the balance between wet and dry performance in a vehicle tire of the type mentioned above.

The object is achieved, according to the invention, in that transverse grooves are provided in which a channel-incision combination, which opens out from the outer surface of the profile rib and has a width of 0.4 mm to 1.2 mm and a tubular channel emanating from the outer surface of the profile rib, the tubular channel adjoining the incision over its entire extent and running around it in an L-shape, the channel having a channel end section tapering towards the end flank.

When the tire rolls, contact of the tread with the ground causes the incisions to open, so that when driving on wet roads, water is absorbed via the incisions and via the channel opening of the tubular channel located on the outer surface of the tread rib. Since water flowing into the incision is diverted into the tubular channel and via its tapering channel end section in an accelerated manner into the transverse groove, the incision-channel combination provided according to the invention ensures effective drainage of the shoulder-side tread rib in the direction of the tread shoulder, so that a good wet performance is guaranteed. The transverse grooves are shorter than usual transverse grooves in the area of the ground contact area, so that the contact area and the rigidity of the shoulder-side profile rib are increased and the dry performance is optimized in this way.

According to a preferred embodiment, the channel outside the channel end section has a diameter of 170% to 300%, in particular from 220% to 280%, preferably from 240% to 260%, of the width of the incision. This measure is also advantageous for the water drainage capacity of the channel and therefore for the wet performance of the tire.

A particularly low-turbulence outflow of the water from the channel into the transverse groove is ensured if the channel end section has the shape of a truncated cone.

According to a further preferred embodiment, the end flank of the channel end section has a diameter of 95% to 105%, in particular 100%, of the width of the incision. This favors an accelerated drainage of the water from the channel into the transverse groove.

According to a further preferred embodiment, the channel is composed of the channel end section, a channel section starting from the outer surface of the profile rib and a central channel section, the channel end section with the central channel section being the longer L-shaped bar and the channel section starting from the outer surface of the profile rib, which forms the shorter L-bar of the L-shape. This contributes to a further improvement in the drainage capacity of the channel-incision combination and thus to a further improvement in the wet performance.

Further refinements help to further improve the last-mentioned preferred embodiment with regards to wet performance.

One of these configurations is that the middle channel section and the channel end section form a common body of revolution with a main axis. This contributes to a low-turbulence water flow in the channel.

It is advantageous if the main axis of the common body of rotation, which is formed by the channel end section and the central channel section, is at a depth determined in the radial direction of 45% to 75%, in particular from 50% to 70%, particularly preferably from 55% up to 65%, of the maximum depth of the transverse groove. This measure also contributes to maintaining a high level of rigidity of the shoulder-side profile rib in the area of the channel and is therefore also advantageous for dry performance.

In addition, it is advantageous in this embodiment if the middle channel section and the channel end section each have a length determined along the main axis, and the length of the channel end section is 30% to 70%, in particular 40% to 60%, preferably 45% to 55%, of the length of the middle section of the channel. Such a channel is particularly advantageous with regard to its water absorption capacity as well as with regard to its water drainage behavior.

According to a further preferred embodiment, the channel has a channel opening on the outer surface of the profile rib, which is at a distance of 2.0 mm to 8.0 mm, in particular up to 5.0 mm, from the shoulder-side circumferential groove, the distance being the smallest possible distance between the shoulder-side circumferential groove and the pitch circle of the radially outer channel opening.

Another embodiment, which is particularly favorable for wet performance, is characterized in that the channel-incision combination with respect to a plane which extends from a top view to the axial direction at an angle of 0° to 10°, in particular 2° to 7°.

In this embodiment, it is advantageous if the plane traverses the transverse groove, viewed in plan view, in its longitudinal extent. This is favorable for the drainage of water from the incision-channel combination into the transverse groove as well as the forwarding of the water into the area outside the ground contact area.

Furthermore, it is advantageous in this embodiment if the end flank of the transverse groove is composed of a radially inner end flank section directly adjoining the groove base and a radially outer end flank section which extends to the outer surface of the profile rib and via which the incision-channel combination opens into the transverse groove, where the radially outer end flank section, viewed in the projected cross section, extends to the radial direction at an angle of 0° to 10°, in particular from 3° to 7°, and wherein the radially inner end flank section, viewed in the cross section lying in the plane, runs in a circular arc and connects to the bottom of the groove without kinks. The radially outer end flank section has a supporting effect on the transverse groove, locally stiffens the transverse groove and thus the shoulder-side profile rib, which is favorable with regard to the dry performance. The radially inner flank section running in the shape of an arc of a circle contributes to a low-turbulence water flow from the channel into the transverse groove. This design is therefore of particular advantage for the balance between wet and dry performance.

According to a further preferred embodiment, the transverse groove, viewed in plan view, has a main section running in sections inside and in sections outside the ground contact area and a tapering section adjoining the tread-inner end of the main section, in which the end flank is formed and which extends from the main section to the incision on the outer surface of the tread rib continuously. The tapering section contributes to a low-turbulence water flow from the channel-incision combination into the main section. The main section is beneficial for the drainage performance of the transverse groove.

In this context, it is also advantageous if the main section within the ground contact area on the outer surface of the profile rib has a width of from 3.0 mm to 7.0 mm.

At the level of the outer surface of the tread rib, the tapered section has a width of 1.5 mm to 3.0 mm, preferably at most 2.0 mm, at its end on the inside of the tread.

### BRIEF DESCRIPTION OF THE SEVERAL VIEWS OF THE DRAWING(S)

Further features, advantages and details of the invention will now be explained in more detail with reference to the drawings, which schematically shows one nonlimiting embodiment of the invention.

FIG. 1 shows a plan view of a circumferential section of a shoulder-side profile rib of a tread of a pneumatic vehicle tire with an embodiment variant of the invention;

FIG. 2 is an enlarged plan view of the detail Z₂ of FIG. 1;

FIG. 3 shows an enlarged section along the line in FIG. 2;

FIG. 4 shows a detailed view according to the viewing direction indicated in FIG. 2 by the Peil S₄;

FIG. 5 shows an enlarged oblique view cut away along the line V-V in FIG. 2; and

FIG. 6 shows an enlarged section along the line VI-VI in FIG. 2.

### DETAILED DESCRIPTION

Pneumatic vehicle tires designed according to the invention are tires for motor vehicles, in particular for multi-lane motor vehicles, as well as preferably radial tires for passenger cars, vans or light trucks (light trucks with GVW≤7.5 tons).

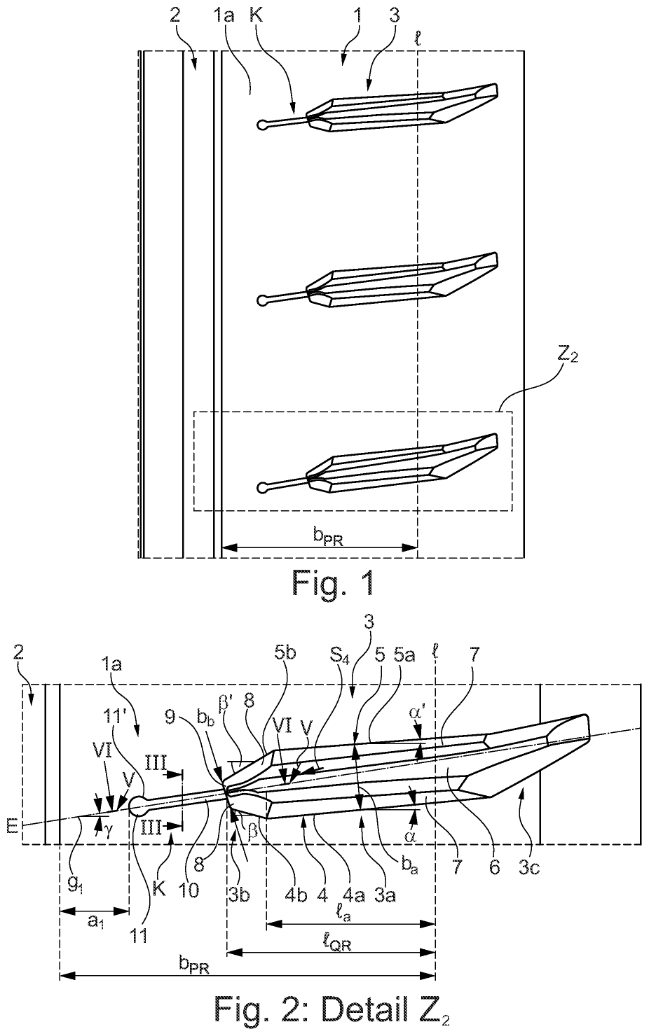

FIG. 1 shows a circumferential section of a shoulder-side profile rib 1. The lateral edge of the ground contact area (determined with a tire mounted on a standard rim, load at 70% of the maximum load capacity, internal pressure 85% of the standard pressure, according to ETRTO standards) is indicated by a dashed line 1.

The tread is preferably asymmetrical in relation to the tire equatorial plane, so that in the second shoulder-side tread area, not shown, a shoulder-side tread rib is formed, the configuration of which deviates from that of the shoulder-side tread rib 1 shown and the pneumatic vehicle tire being mounted on a vehicle in such a way that the shoulder-side profile rib 1 shown is arranged toward the inside of the vehicle.

The shoulder-side tread rib 1 has a tread rib outer surface 1a located on the tread periphery and a width b_{PR} determined in the axial direction within the ground contact area at the tread periphery, and is on the inside of the tread from a shoulder-side circumferential groove that is indicated in FIG. 2, which is designed in the respective intended profile depth, which for passenger cars, vans or light trucks is usually 6.5 mm to 8.5 mm.

Furthermore, the shoulder-side profile rib 1 is provided over its circumferential extent with a plurality of shoulder-side transverse grooves 3 running parallel to one another in plan view, which extend beyond the lateral edge (line 1) of the ground contact area and inside the shoulder-side profile rib 1 at a distance determined in the axial direction the shoulder-side circumferential groove 2 ends. The end of each transverse groove 3 on the inside of the tread is adjoined by a channel-incision combination K formed in the shoulder-side profile rib 1.

The further configuration of the shoulder-side transverse grooves 3 is explained below with reference to a single transverse groove 3 with an associated channel-incision combination K and with reference to FIGS. 2 to 6.

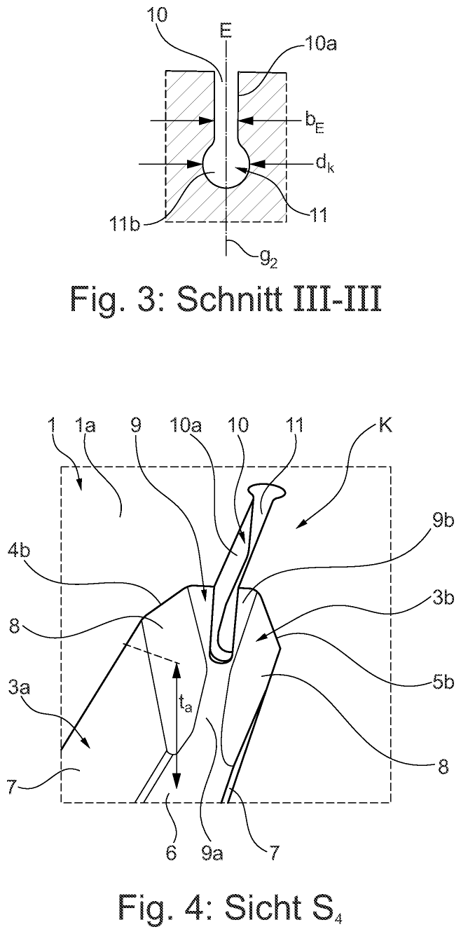

According to FIG. 2, the channel-incision combination K, the configuration of which will be discussed in detail later, is in relation to a plane E which extends from a top view to the axial direction at an angle γ of 0° to 10°, in particular of 2° to 7°, and extending straight line g₁ and a straight line g₂ extending in the radial direction (FIG. 3) are formed symmetrically.

The transverse groove 3 is designed in such a way that the plane E, viewed in plan view, crosses the transverse groove 3 in its longitudinal extent, so that the plane E defines the direction of extent of the transverse groove 3. The transverse groove 3 has, within the ground contact area, a length l_{QR} of 45% to 65%, in particular 50% to 60%, of the width b_{PR} of the shoulder-side tread rib 1, determined on the outer surface of the tread rib 1 and related to the plane E and projected in the axial direction. The transverse groove 3, viewed in plan view, is composed of a main section 3a running in sections inside and in sections outside the ground contact area, a tapering shoulder section 3c located outside the ground contact area and a tapering section 3b adjoining the tread inside end of the main section 3a. Furthermore, the transverse groove 3 on the tread rib outer surface 1a has two groove edges 4, 5 which extend beyond the ground contact area and which each extend over the main section 3a, the tapered section 3b and the shoulder section 3c.

The groove edges 4, 5 have an edge section 4a or 5a running in the main section 3a and an edge section 4b or 5b running in the tapered section 3b. When viewed from above, the edge sections 4a, 5a run straight and to the axial direction at an angle α (edge section 4a) or α′ (edge section 5a), the angles α, α′ each being from 0° to 10°, in particular from 2° to 7°, and wherein the edge sections 4a, 5a in the illustrated embodiment are inclined in the same direction with respect to the axial direction. When viewed from above, the edge sections 4b and 5b also run straight and to the axial direction at an angle β (edge section 4b) or β′ (edge section 5b), the angles β, β′ each being from 15° to 30° and where the edge sections 4b, 5b are inclined in opposite directions to one another with respect to the axial direction in such a way that they approach one another in the direction of the shoulder-side circumferential groove 2. The angle β and the angle β′ can differ from one another, in particular by up to 10°.

The main section 3a has, in each case within the ground contact area, a length lₐ determined on the profile rib outer surface 1a, referred to the plane E and projected in the axial direction, of from 70% to 90%, and in particular from 75% to 80%, of the length l_{QR} of the transverse groove 3, a maximum depth to determined in the radial direction (FIG. 4) of from 75% to 100%, in particular a maximum of 95%, of the profile depth and a width b a determined as the smallest possible distance between the edge section 4a and the edge section 5a of 3.0 mm to 7.0 mm. The length lₐ is also related to the tread inside end of that edge section 4a, 5a which is further inside the tread. The main section 3a is characterized by a groove base 6 and two groove flanks 7, one of which starts from the edge section 4a and the other from the edge section 5a, and which, viewed in cross section perpendicular to the associated edge section 4a, 5a, to the radial direction at an angle of from 0° to 5°.

The tapered section 3b narrows at the level on the outer surface of the tread ribs 1a starting from the main section 3a continuously in the direction of the shoulder-side circumferential groove 2 and has a width b_{b} of from 1.5 mm to 3.0 mm, preferably of from 1.5 mm to 3.0 mm, determined between the ends of the edge sections 4b and 5b on the inside of the tread, at most 2.0 mm. As FIG. 2 shows, in particular in combination with FIG. 4, the tapering section 3b is delimited by two lateral flanks 8 and one end flank 9. The lateral flanks 8 start from the edge sections 4b, 5b, adjoin the groove flanks 7 and run, viewed in cross section perpendicular to the associated edge section 4b, 5b, to the radial direction at an angle of from 0° to 5°, and in particular of at least 2°. The end flank 9 extends between the flanks 8, adjoins the groove base 6 and, as a continuation of this, extends to the outer surface of the ribbed profile 1a.

According to FIGS. 4 and 6, the end flank 9 is composed of a radially inner end flank section 9a directly adjoining the groove base 6 and a radially outer end flank section 9b. As FIG. 6 shows, the radially inner end flank section 9a, viewed in the cross section lying in the plane E (see position of the section line VI-VI in FIG. 2), runs in the shape of a circular arc and adjoins the groove base 6 without kinks. The radially outer end flank section 9b, viewed in the cross-section projected into the plane E, runs straight to the radial direction and at an angle δ of 0° to 10°, and in particular 3° to 7°.

As FIGS. 4 to 6 show together, the already mentioned channel-incision combination K is formed from a tubular channel 11 with a circular cross-section and an incision 10 opening into this, the incision 10 and the channel 11 together open into the tapered section 3b of the transverse groove 3 and, in accordance with the mentioned symmetrical configuration of the channel-incision combination K, and both the channel 11 and the incision 10 are symmetrical with respect to the plane E (see FIGS. 2 and 3).

The incision 10 starts from the outer surface 1a of the profile rib, runs in the radial direction into the interior of the shoulder-side profile rib 1, opens into the tapering portion 3b via the radially outer end flank portion 9b and has two incision walls 10a aligned in the radial direction and a constant width b_{E} (FIG. 3) from 0.4 mm to 1.2 mm, in particular from 0.6 mm to 1.0 mm, the width b_{E} being made smaller than the already mentioned width b_{b} belonging to the tapered section 3b (FIG. 2).

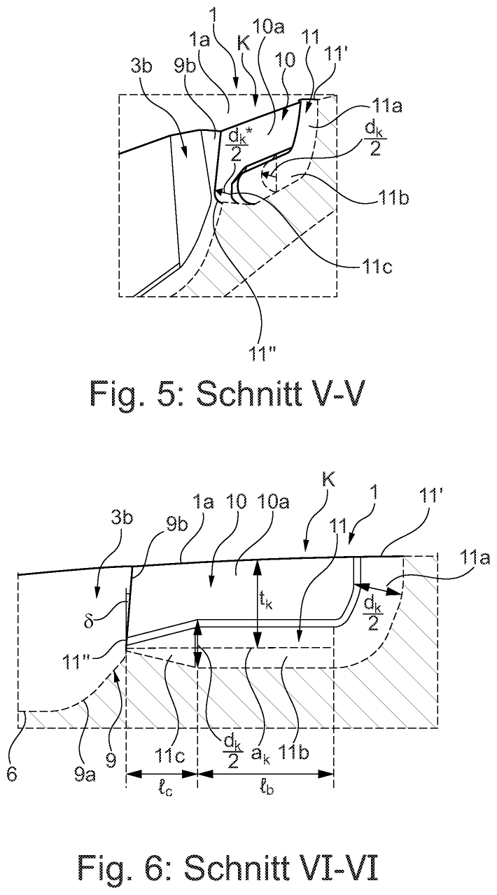

According to FIGS. 5 and 6, the tubular channel 11 runs between the profile rib outer surface 1a and the tapered section 3b, the channel 11 being formed in the interior of the profile rib 1 over its entire extent adjacent to the incision 10, so that it has, as viewed in the plane E lying cross sectionally (see FIG. 6, section line VI-VI from FIG. 2), roughly an L-shape.

The channel 11 is composed of a channel section 11a, a central channel section 11b and a tapering channel end section 11c. The channel section 11a starts from the profile rib outer surface 1a, has a circular channel opening 11′ on this, forms the shorter L-bar of the L-shape, runs, viewed in the cross-section lying in the plane E, slightly curved, in particular semi-U-curved in shape (FIG. 6), and has a diameter dₖ (FIG. 6) of 170% to 300%, in particular from 220% to 280%, preferably from 240% to 260%, of the width b_{E} (FIG. 3) of the Incision 10. The channel opening 11′ has a distance a₁ (FIG. 2) from the shoulder-side circumferential groove 2 of 2.0 mm to 8.0 mm, in particular up to 5.0 mm, the distance a1 being the smallest possible distance between the shoulder-side circumferential groove 2 and the hole circle of the channel opening 11′ is determined. The channel section 11b and the channel end section 11c run radially inside the incision 10, form the longer L-beam of the L-shape and furthermore form a body of revolution with a main axis aₖ (FIG. 6), which extends in a radial direction depth tₖ of 45% to 75%, in particular from 50% to 70%, particularly preferably from 55% to 65%, of the maximum depth to (FIG. 4) of the main section 3a of the transverse groove 3 is located. The channel section 11b likewise has the already mentioned diameter dₖ and also a length l_{b} determined along the main axis aₖ (FIG. 6). The channel end section 11c is designed in the form of a truncated cone, has a channel opening 11″ located on the radially outer end flank section 9b of the end flank 9 of the transverse groove 3 and a length l_{c} determined along the main axis aₖ (FIG. 6), the length l_{c} being from 30% up to 70%, in particular from 40% to 60%, preferably from 45% to 55%, of the length l_{b} (FIG. 6). The channel end section 11c narrows continuously starting from the channel section 11b to the tapering section 3b of the transverse groove 3, has a diameter dₖ at the channel section 11b and a diameter dₖ* (FIG. 5) of 95% to 105%, in particular 100%, at the channel opening 11″, of the width b_{E} of the incision 10.

The invention is not restricted to the exemplary embodiment described.

The tapering section 3a and the shoulder section 3c of the transverse groove 3 are optional, where in this embodiment the main section 3a of the transverse groove 3 is preferably continued on the outside of the tread, that is to say it is lengthened. The transverse groove 3 can be provided on the groove flanks with chamfers (inclined surfaces) which are implemented in a particularly known manner. Furthermore, in addition to the transverse grooves 3, further transverse grooves can be provided in the shoulder-side profile rib. The tread can also have a shoulder-side profile rib in each shoulder, which is designed as described.

### LIST OF REFERENCE NUMERALS (PART OF THE DESCRIPTION)

1 shoulder-side profile rib
1a outer surface of the tread ribs
2 shoulder-side circumferential groove
3 shoulder-side transverse groove
3a main section
3b taper section
3c shoulder section
4 groove edge
4a edge section
4b edge section
5 groove edge
5a edge section
5b edge section
6 groove bottom
7 groove flank
8 side flank
9 end flank
9a radially inner end flank section
9b radially outer end flank section
10 incision
10a incision wall
11 channel
11a channel section
11b channel section
11c channel end section
11′ channel opening
11″ channel opening
a₁ distance
aₖ main axis
bₐ, b_{b}, b_{E}, b_{PR} width
dₖ, dₖ* diameter
E plane
g₁, g₂ straight line
K channel-incision combination
l line (lateral edge of the ground contact area)
lₐ, l_{b}, l_{QR} length
tₐ, tₖ maximum depth
S₄ arrow (viewing direction)
Z₂ detail
α, α′, β, β′, γ, δ angles

1-16. (canceled)

17. A pneumatic vehicle tire comprising:
a tread with a shoulder-side tread rib delimited by a circumferential groove with an outer tread-rib surface lying in the tread periphery;
the shoulder-side tread rib having a plurality of parallel tread ribs in plan view;
the circumferential groove has ending transverse grooves;
the transverse grooves are each provided with a groove base and an end flank which adjoins the groove base on the inside of the tread and continues to the outer surface of the tread rib surface (1a);
the transverse grooves are provided, in each of which is a channel-incision combination (K) emanating from the outer surface of the profile rib and which opens out over the end flank into the respective transverse groove within the shoulder-side profile rib; and,
an incision is formed in the shoulder-side profile rib with a width (b_{E}) of from 0.4 mm to 1.2 mm, and a tubular channel extends from the profile rib outer surface;
the tubular channel extending over its entire extent adjoins the incision and runs around it in an L-shape, and wherein the channel has a channel end section which tapers towards the end flank (9).

18. The tire of claim 17, wherein the channel outside the channel end section has a diameter (dₖ) of 240% to 260% of the width (b_{E}) of the incision (10).

19. The tire of claim 18, wherein the channel end section has the shape of a truncated cone.

20. The tire of claim 19, wherein the channel end section on the end flank has a diameter (dₖ*) of 95% to 105% of the width (b_{E}) of the incision.

21. The tire of claim 20, wherein the channel is composed of the channel end section (11c), a channel section (11a) extending from the tread rib outer surface (1a) and a central channel section (11b), wherein the channel end section (11c) along with the central channel section (11b) forms the longer L-bar of the L-shape, and wherein the channel section (11a) which extends from the outer surface of the profile rib (1a) forms the shorter L-bar of the L-shape.

22. The tire of claim 21, wherein the central channel section (11b) and the channel end section (11c) form a common rotational body with a main axis (aₖ).

23. The tire of claim 22, wherein the main axis (aₖ) of the common rotational body, which is formed by the channel end section (11c) and the central channel section (11b), is at a depth (tₖ) determined in the radial direction of 55% to 65% of the maximum depth (tₐ) of the transverse groove.

24. The tire of claim 23, wherein the middle channel section (11b) and the channel end section (11c) each have a length (l_{b}, l_{c}) determined along the main axis (aₖ), and wherein the length (l_{c}) of the channel end section (11c) is from 30% to 70%, in particular from 40% to 60%, preferably from 45% to 55%, of the length (l_{b}) of the central channel section (11b).

25. The tire of claim 17, wherein the channel on the outer surface of the tread rib (1a) has a channel opening (11′) which is at a distance (a₁) of 2.0 from the shoulder-side circumferential groove (2) mm to 8.0 mm, in particular up to 5.0 mm, the distance (a₁) being determined as the smallest possible distance between the shoulder-side circumferential groove (2) and the hole circle of the radially outer channel opening (11′).

26. The tire of claim 17, wherein the channel-incision combination (K) with respect to a plane (E) which extends from a top view to the axial direction at an angle (γ) of from 0° to 10°, in particular from 2° to 7°, and wherein a straight line (g₁) and a straight line (g₂) extending in the radial direction are formed symmetrically.

27. The tire of claim 26, in that the plane (E) traverses the transverse groove (3), viewed in plan view, in its longitudinal extension.

28. The tire of claim 27, wherein the end flank (9) of the transverse groove (3) consists of a radially inner end flank section (9a) directly adjoining the groove base (6) and a radially extending to the outer surface of the tread ribs (1a) outer end flank section (9b), via which the incision-channel combination (K) opens into the transverse groove (3), the radially outer end flank section (9b), viewed in the projected cross-section in the plane (E), facing the radial direction runs at an angle (δ) from 0° to 10°, in particular from 3° to 7°, and wherein the radially inner end flank section (9a), viewed in the cross-section lying in the plane (E), runs in the shape of a circular arc and without kinks to the groove base (6) connects.

29. The tire of claim 17, wherein the transverse groove, viewed in plan view, has a main section (3a) running in sections inside and in sections outside the ground contact area and a main section (3a) adjoining the end of the main section (3a) on the inside of the tread Tapering section (3b) in which the end flank (9) is formed and which continuously narrows on the outer surface of the profile rib (lₐ) from the main section (3a) to the incision (10).

30. The tire of claim 29, wherein the main section (3a) has a width (b a) of 3.0 mm to 7.0 mm within the ground contact area on the outer surface of the tread rib (lₐ).

31. The tire of claim 30, wherein the tapered section (3b) at the level of the outer surface of the tread rib (1a) has a width (b_{b}) of from 1.5 mm to 3.0 mm, preferably at most 2, at its tread inner end.
